(19) United States
(12) Patent Application Publication
(10) Pub. No.: US 2011/0304539 A1
(43) Pub. Date: Dec. 15, 2011

(54) REMOTE CONTROLLING APPARATUS AND METHOD FOR CONTROLLING THE SAME

(76) Inventors: Janghee LEE, Seoul (KR); Sanghyun Cho, Gyeonggi-Do (KR); Sijin Kim, Seoul (KR)

(21) Appl. No.: 13/157,901

(22) Filed: Jun. 10, 2011

(30) Foreign Application Priority Data
Jun. 11, 2010 (KR) 10-2010-0055580

(51) Int. Cl. G06F 3/033

(52) U.S. Cl. 345/158

(57) ABSTRACT

Disclosed are a remote controlling apparatus and a method for controlling the same, the apparatus capable of intuitively and conveniently controlling a display apparatus and capable of simply and precisely performing a text input, by controlling activation of a text input unit based on tilt information of the remote controlling apparatus having a three-dimensional pointing function. The remote controlling apparatus for controlling a pointer displayed on a screen of a display apparatus by a three-dimensional operation includes a housing, a text input unit disposed on one surface of the housing, and configured to receive a text input, a sensing unit configured to detect a tilt and a motion of the remote controlling apparatus, and a controller configured to selectively operate a first mode to transmit the text input to the display apparatus or a second mode to transmit information on the detected motion of the remote controlling apparatus to the display apparatus based on the detected tilt of the remote controlling apparatus.

### CROSS-REFERENCE TO RELATED APPLICATION

This application claims the benefit of Korean Patent Application No. 10-2010-0055580, filed on Jun. 11, 2010, which is hereby incorporated by reference for all purposes as if fully set forth herein.

### BACKGROUND OF THE INVENTION

1. Field of the Invention

This specification relates to a remote controlling apparatus and a method for controlling the same, and particularly, to a remote controlling apparatus having a three-dimensional pointing function and a method for controlling an input thereof.

2. Background of the Invention

An image display apparatus is an apparatus having a function to display an image viewable by a user. Recently, this image display apparatus is provided with various functions. For instance, a digital television (DTV) is provided with a function to receive an electronic program guide (EPG), a bi-directional communication function, an internet access function, etc. as well as a function to receive an analogue or digital broadcasting. Furthermore, the DTV performs a function of a server at a home network environment or a ubiquitous environment.

As the image display apparatus performs various functions, a method for controlling the image display apparatus by a user becomes more complicated. Complicated and various graphic user interfaces (GUI), media and functions cannot be efficiently controlled by the conventional button type remote controller. To solve this problem, the conventional remote controller having an infrared-ray communication method has been replaced by a space remote controller having a three-dimensional pointing function.

A plurality of key buttons of the space remote controller are replaced by a pointing function. However, the space remote controller has a difficulty in performing a text input required for a user to perform functions such as searching for web sites, schedule managements, photo editions, etc.

### SUMMARY OF THE INVENTION

Therefore, an aspect of the detailed description is to provide a remote controlling apparatus capable of intuitively and conveniently controlling a display apparatus and capable of simply and precisely performing a text input, by controlling activation of a text input unit based on tilt information of the remote controlling apparatus having a three-dimensional pointing function, and a method for controlling the same.

To achieve these and other advantages and in accordance with the purpose of this specification, as embodied and broadly described herein, there is provided a remote controlling apparatus for controlling a pointer displayed on a screen of a display apparatus by a three-dimensional operation, the remote controlling apparatus comprising: a housing; a text input unit disposed on one surface of the housing, and configured to receive a text input; a sensing unit configured to detect a tilt and a motion of the remote controlling apparatus; and a controller configured to selectively operate a first mode to transmit the text input to the display apparatus or a second mode to transmit information on the detected motion of the remote controlling apparatus to the display apparatus based on the detected tilt of the remote controlling apparatus.

The controller may control receiving the text input to be activated and detecting the motion of the remote controlling apparatus to be deactivated if the detected tilt of the remote controlling apparatus is a first value.

The controller may control receiving the text input to be deactivated and detecting the motion of the remote controlling apparatus to be activated if the detected tilt of the remote controlling apparatus is a second value.

The remote controlling apparatus may further comprise an operation control input unit configured to control a broadcasting-related operation of the display apparatus in the second mode.

The operation control input unit may be disposed on a surface facing one surface of the housing.

The controller may selectively operate the first mode or the second mode based on whether one surface of the housing is toward a geocentric direction or an opposite direction to the geocentric direction.

The operation control input unit may be disposed on the same surface as one surface of the housing.

The remote controlling apparatus may be formed in a rectangular-parallelepiped-shape, and the controller selectively operate the first mode or the second mode based on a longitudinal direction is a horizontal direction or a vertical direction.

The remote controlling apparatus may further comprise a display unit configured to display one or more function keys of the text input unit, and one or more function keys of the operation control input unit. And, the controller may be configured to control the display unit such that one or more function keys of one activated input unit between the text input unit and the operation control input unit are displayed.

The text input unit may be implemented as a QWERTY type keyboard or a non-QWERTY type keyboard.

The sensing unit may comprise an acceleration sensor to detect the tilt of the remote controlling apparatus and a gyro sensor to detect the motion of the remote controlling apparatus.

The remote controlling apparatus may further comprise a wireless communication unit configured to transmit the text input to the display apparatus in the first mode and the information on the motion of the remote controlling apparatus to the display apparatus in the second mode.

To achieve these and other advantages and in accordance with the purpose of this specification, as embodied and broadly described herein, there is also provided a remote controlling apparatus for controlling a pointer displayed on a screen of a display apparatus by a three-dimensional operation, the remote controlling apparatus comprising: a housing; a text input unit disposed on one surface of the housing, and configured to receive a text input; a sensing unit configured to detect a tilt of the remote controlling apparatus; and a controller configured to selectively operate a first mode to transmit the text input to the display apparatus or a second mode to transmit information on the detected tilt of the remote controlling apparatus based on the detected tilt of the remote controlling apparatus.

The controller may control receiving the text input to be activated if the detected tilt of the remote controlling apparatus is a first value.

The controller controls receiving the text input to be deactivated if the detected tilt of the remote controlling apparatus is a second value.

The remote controlling apparatus may further comprise an operation control input unit configured to control a broadcasting-related operation of the display apparatus in the second mode.

The operation control input unit may be disposed on a surface facing one surface of the housing.

The operation control input unit may be disposed on the same surface as one surface of the housing.

The remote controlling apparatus may be a mobile terminal.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram showing an inner structure of an image display apparatus according to the present invention;

FIGS. 2A to 2C are views each showing an operation of a remote controlling apparatus of FIG. 1;

FIG. 3 is a view for explaining three axes relating to a tilt of the remote controlling apparatus according to the present invention;

FIG. 4 is a block diagram showing an inner structure of a remote controlling apparatus of FIG. 1;

FIG. 5A is a view showing function keys of an operation control input unit according to the present invention;

FIG. 5B is a view showing function keys of a text input unit according to the present invention;

FIG. 6A is a front perspective view of a remote controlling apparatus according to the present invention;

FIG. 6B is a rear perspective view of the remote controlling apparatus of FIG. 6A;

FIGS. 7A to 7C are conceptual views for explaining a method for controlling an operation of a remote controlling apparatus according to a first embodiment of the present invention;

FIG. 8A is a view showing a threshold value table of a remote controlling apparatus according to a first embodiment of the present invention;

FIG. 8B is a view showing an activated region and a deactivated region of a remote controlling apparatus according to a first embodiment of the present invention;

FIGS. 9A to 9C are conceptual views for explaining a method for controlling an operation of a remote controlling apparatus according to a second embodiment of the present invention;

FIG. 10A is a view showing a threshold value table of a remote controlling apparatus according to a second embodiment of the present invention;

FIG. 10B is a view showing an activated region and a deactivated region of a remote controlling apparatus according to a second embodiment of the present invention;

FIG. 11 is a flowchart showing processes for controlling an operation of a remote controlling apparatus according to the present invention; and

FIG. 12 is a flowchart showing a step of determining operation mode (S200) of FIG. 11.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated. Hereinafter, a remote controlling apparatus and a method for controlling the same according to the present invention will be explained in more detail with reference to the attached drawings. The suffixes attached to components, such as ‘module’ and ‘unit or portion’ were used for facilitation of the detailed description of the present invention. Therefore, the suffixes do not have different meanings from each other.

The term disclosed in the present descriptions, “three-dimensional pointing” indicates that a remote controlling apparatus moves in a space in front of an image display apparatus in a three or more dimensional manner, and a user interface converts motions of the remote controlling apparatus into a user interface command, for instance, motions of a pointer on a display screen of the image display apparatus. The remote controlling apparatus may transmit, to the image display apparatus, data regarding an operation of the pointer in a wired or wireless manner.

The three-dimensional pointing method includes an absolute pointing method for determining a motion of a pointer according to an indication direction by the remote controlling apparatus, and a relative pointing method for determining a motion of a pointer with using an inertia sensor according to a motion of the remote controlling apparatus regardless of an indication direction by the remote controlling apparatus. Both the absolute pointing method and the relative pointing method may be applied to the present invention.

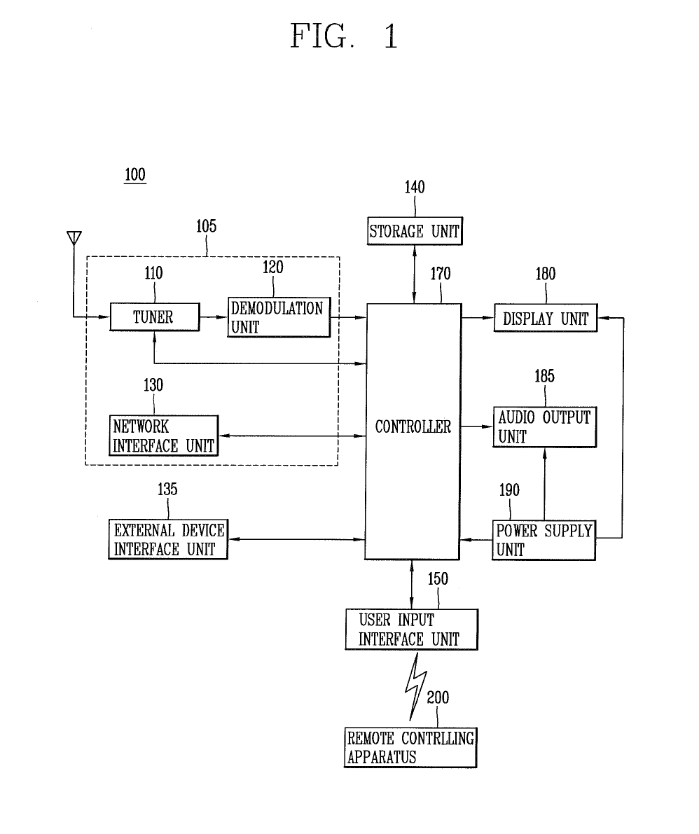

FIG. 1 is a block diagram showing an inner structure of an image display apparatus according to the present invention.

Referring to FIG. 1, the image display apparatus 100 according to the present invention comprises a broadcasting receiving unit 105, an external device interface unit 135, a storage unit 140, a user input interface unit 150, a controller 170, a display unit 180, an audio output unit 185 and a power supply unit 190. The broadcasting receiving unit 105 may include a tuner 110, a demodulation unit 120 and a network interface unit 130. Either the tuner 110 and the demodulation unit 120, or the interface unit 130 may be selectively provided. The tuner 110 selects, from a radio frequency (RF) broadcasting signal received through an antenna, an RF broadcasting signal corresponding to a channel selected by a user or all of pre-stored channels. And, the tuner 110 converts the selected RF broadcasting signal into an intermediate frequency signal or a base band image or an audio signal.

For instance, when a selected RF broadcasting signal is a digital broadcasting signal, the tuner 110 converts the digital broadcasting signal into a digital IF signal (DIF). On the contrary, when a selected RF broadcasting signal is an analogue broadcasting signal, the tuner 110 converts the analogue broadcasting signal into an analogue base band image or an audio signal (CVBS/SIF). More concretely, the tuner 110 may process a digital broadcasting signal or an analogue broadcasting signal. The analogue base band image or the audio signal (CVBS/SIF) output from the tuner 110 may be directly input to the controller 170.

The tuner 110 may receive an RF broadcasting signal of a single carrier according to an ATSC (Advanced Television System Committee) method, or an RF broadcasting signal of a plurality of carriers according to a DVB (Digital Video Broadcasting) method. And, the tuner 110 may sequentially select RF broadcasting signals of all broadcasting channels stored through a channel memory function, from RF broadcasting signals received through an antenna. Then, the tuner 110 may convert the selected RF broadcasting signals into intermediate frequency signals or base band images or audio signals.

The demodulation unit 120 receives the digital IF signal (DIF) converted by the tuner 110, and demodulates the received DIF. For instance, when the DIF converted by the tuner 110 has an ATSC standard, the demodulation unit 120 performs an 8-VSB (8-Vestigal Side Band) demodulation. The demodulation unit 120 may perform a channel decoding. For instance, the demodulation unit 120 may perform operations of trellis decoding, de-interleaving and reed solomon decoding by being provided with a trellis decoder, a de-interleaver and a reed solomon decoder.

For instance, when the DIF output from the tuner 110 has a DVB standard, the demodulation unit 120 performs a coded orthogonal frequency division modulation (COFDMA). The demodulation unit 120 may perform a channel decoding. For instance, the demodulation unit 120 may perform operations of convolution decoding, de-interleaving and reed solomon decoding by being provided with a convolution decoder, a de-interleaver and a reed solomon decoder.

The demodulation unit 120 may perform operations of demodulation and channel decoding, and then output a stream signal (TS). Here, the stream signal may be a signal formed by multiplexing a video signal, an audio signal and a data signal with one another. For instance, the stream signal may be an MPEG-2 TS (Transport Stream) formed by multiplexing a video signal of an MPEG-2 standard, an audio signal of a Dolby AC-3 standard, etc. with one another. More concretely, the MPEG-2 TS may include a header of 4 bytes and a payload of 184 bytes.

The demodulation unit 120 may consist of individual demodulation units according to an ATSC standard and a DVB standard. More concretely, the demodulation unit 120 may be implemented as an ATSC demodulation unit and a DVB demodulation unit.

The stream signal output from the demodulation unit 120 may be input to the controller 170. The controller 170 performs functions of demultiplexing, image/audio signal processing, etc. Then, the controller 170 outputs a video signal to the display unit 180, and outputs an audio signal to the audio output unit 185.

The external device interface unit 135 may connect an external device to the image display apparatus 100. For this, the external device interface unit 135 may include an A/V input/output unit (not shown) or a wireless communication unit (not shown).

The external device interface unit 135 may be connected to an external device in a wired or wireless manner, the external device such as a DVD (Digital Versatile Disk), a Blu ray, a game device, a camera, a camcorder and a computer (notebook). The external device interface unit 135 transmits, to the controller 170 of the image display apparatus 100, a video signal, or an audio signal, or a data signal input from the outside through an external device connected thereto. And, the external device interface unit 135 may output the video signal, or the audio signal, or the data signal processed by the controller 170 to the external device. For this, the external device interface unit 135 may include an A/V input/output unit (not shown) or a wireless communication unit (not shown).

In order to input video and audio signals generated from an external device to the image display apparatus 100, the A/V input/output unit may include a USB terminal, a CVBS (Composite Video Banking Sync) terminal, a component terminal, an S-video terminal (analogue), a DVI (Digital Visual Interface) terminal, a HDMI (High Definition Multimedia Interface) terminal, an RGB terminal, a D-SUB terminal, etc.

The wireless communication unit may perform a short-range wireless communication with other electronic device. The image display apparatus 100 may be connected to other electronic device through a network according to a communication standard, such as Bluetooth, RFID (Radio Frequency Identification), IrDA (Infrared Data Association), UWB (Ultra Wideband), ZigBee and DLNA (Digital Living Network Alliance). And, the external device interface unit 135 may be connected to various set-top boxes through one of the aforementioned terminals, thereby performing inputs and outputs with the set-top boxes. The network interface unit 130 provides an interface for connecting the image display apparatus 100 to a wired/wireless network including an internet network. The network interface unit 130 may be provided with an Ethernet terminal for connection with a wired network, and may utilize communication standards such as WLAN (Wireless LAN)(Wi-Fi), Wibro (Wireless broadband), Wimax (World Interoperability for Microwave Access), and HSDPA (High Speed Downlink Packet Access) for connection with a wireless network.

The network interface unit 130 may access a predetermined web page through a network. More concretely, the network interface unit 130 may access a predetermined web page through a network thus to perform data transmission or data reception with a corresponding server. Also, the network interface unit 130 may receive contents or data provided from a contents provider or a network operator. More concretely, the network interface unit 130 may receive contents of a film, an advertisement, a game, a VOD, a broadcasting signal, etc. provided from a contents provider or a network provider through a network, and information relating to the contents. The network interface unit 130 may receive update information and an update file of a firmware provided from a network operator. The network interface unit 130 may transmit data to an internet or contents provider or a network operator.

And, the network interface unit 130 may receive, through a network, a desired application by selecting from applications open to the public.

The storage unit 140 may store therein programs for processing and controlling each signal inside the controller 170, or may store therein a processed video or audio or data signal.

The storage unit 140 may temporarily store therein a video signal or an audio signal or a data signal input from the external device interface unit 135 or the network interface unit 130. The storage unit 140 may store therein information relating to a predetermined broadcasting channel through a channel memory function. The storage unit 140 may store therein an application or an application list input from the external device interface unit 135 or the network interface unit 130.

The storage unit 140 may include at least one storage medium of a flash memory type, a hard disk type, a multimedia card micro type, a card type memory (e.g., SD or XD memory), RAM and ROM (EEPROM). The image display apparatus 100 may play a contents file stored in the storage unit 140, such as a moving image file, a still image file, a music file, a document file and an application file, thereby providing the played contents file to a user.

FIG. 1 illustrates a case that the storage unit 140 is separately provided from the controller 170. However, the present invention is not limited to this. That is, the storage unit 140 may be included in the controller 170. The user input interface unit 150 may transmit a user input signal received from the remote controlling apparatus 200 to the controller 170, or may transmit a signal from the controller 170 to a user. For instance, the user input interface unit 150 may receive a user input signal or a control signal, such as power ON/OFF, channel selection and screen setting, from the remote controlling apparatus 200 according to various communication methods such as a radio frequency (RF) communication method and an infrared ray (IR) communication method. Alternatively, the user input interface unit 150 may transmit a control signal from the controller 170 to the remote controlling apparatus 200.

The user input interface unit 150 may transmit, to the controller 170, a user input signal or a control signal input from a local key (not shown) such as a power key, a channel key, a volume key and a setting key. Alternatively, the user input interface unit 150 may transmit a user input signal or a control signal input from a sensing unit (not shown) for sensing a user's gesture to the controller 170, or may transmit a signal from the controller 170 to the sensing unit. Here, the sensing unit may include a touch sensor, a microphone, a position sensor, an operation sensor, etc.

The controller 170 may demultiplex a stream input from the tuner 110 or the demodulation unit 120 or the external device interface unit 135. Alternatively, the controller 170 may generate and output a video signal or an audio signal by processing the demultiplexed signal. A video signal processed by the controller 170 may be input to the display unit 180, thereby being displayed as an image corresponding to the video signal. Alternatively, the video signal processed by the controller 170 may be input to an external output device through the external device interface unit 135.

An audio signal processed by the controller 170 may be output to the audio output unit 185. Alternatively, the audio signal processed by the controller 170 may be input to the external output device through the external device interface unit 135.

Although not shown in FIG. 1, the controller 170 may include a demultiplexing unit, an image processor, etc.

The controller 170 may control the overall operation of the image display apparatus 100. For instance, the controller 170 may tune an RF broadcasting corresponding to a channel selected by a user or a pre-stored channel by controlling the tuner 110.

The controller 170 may control the image display apparatus 100 by a user command input through the user input interface unit 150, or an inner program. Especially, the controller 170 may download a user's desired application or an application list in the image display apparatus 100 by accessing a network.

For instance, the controller 170 controls the tuner 110 such that a signal of a channel selected by a channel selection command received through the use input interface unit 150 is input. Then, the controller 170 processes a video signal or an audio signal or a data signal of the selected channel. The controller 170 may control information on a channel selected by a user, to be output on the display unit 180 or through the audio output unit 185, together with a processed video or audio signal.

Alternatively, the controller 170 may control a video signal or an audio signal from an external device input through the external device interface unit 135, e.g., a camera or a camcorder, so as to be output on the display unit 180 or through the audio output unit 185, according to an external device image play command received through the user input interface unit 150.

The controller 170 may control the display unit 180 to display an image. For instance, the controller 170 may control the display unit 180 to display a broadcasting image input through the tuner 110, or an external input image input through the external device interface unit 135, or an image input through the network interface unit 130, or an image stored in the storage unit 140. Here, the image displayed on the display unit 180 may be a still or moving image, or a 2D or 3D image.

When the image display apparatus 100 enters an application viewing mode, the controller 170 may control an application list of applications inside the image display apparatus 100 or downloadable from an external network, to be displayed.

The controller 170 may control an application downloaded from an external network, to be installed and driven, together with various user interfaces. Alternatively, the controller 170 may control an image relating to an application being currently executed, to be displayed on the display unit 180 according to a user's selection.

Although not shown, the image display apparatus 100 may further comprise a channel browsing processor configured to generate a thumbnail image corresponding to a channel signal or an external input signal. The channel browsing processor may receive a stream signal (TS) output from the demodulation unit 120, or a stream signal output from the external device interface unit 135, and may extract an image from the received stream signal to generate a thumbnail image. The generated thumbnail image may be input to the controller 170 as it is or after being decoded. Alternatively, the generated thumbnail image may be input to the controller 170 after being decoded in the form of a stream. The controller 170 may display, on the display unit 180, a thumbnail list including a plurality of thumbnail images by using an input thumbnail image. The thumbnail images included in the thumbnail list may be updated sequentially or simultaneously. This may allow a user to easily check contents of a plurality of broadcasting channels.

The display unit 180 converts a video signal, a data signal and an OSD signal processed by the controller 170, or a video signal and a data signal received from the external device interface unit 135 into RGB signals, thereby generating driving signals. The display unit 180 may be implemented as a PDP, an LCD, an OLED, a flexible display, a 3D display, etc. Alternatively, the display unit 180 may be implemented as a touch screen to serve as an input device as well as an output device.

The audio output unit 185 receives a signal processed by the controller 170, such as a stereo signal, a 3.1 channel signal and a 5.1 channel signal, thereby outputting the processed signal in the form of an audio signal. The audio output unit 185 may be implemented as various types of speakers.

The image display apparatus 100 may further comprise a capturing unit (not shown) configured to capture a user's image. The capturing unit may be implemented as one camera. However, the present invention is not limited to this. That is, the capturing unit may be implemented as a plurality of cameras. Information on images captured by the capturing unit is input to the controller 170.

The image display apparatus 100 may further comprise a sensing unit (not shown) having at least one of a touch sensor, a microphone, a position sensor and an operation sensor so as to detect a user's gesture. Signal detected by the sensing unit may be transmitted to the controller 170 through the user input interface unit 150.

The controller 170 may detect a user's gesture by using images captured by the capturing unit, or signals detected by the sensing unit in a separate or combination manner.

The power supply unit 190 supplies power to the image display apparatus 100. Especially, the power supply unit 190 may supply power to the controller 170 implemented in the form of a system on chip (SOC), the display unit 180 for displaying an image, and the audio output unit 185 for outputting an audio signal.

The power supply unit 190 may be provided with a converter (not shown) for converting an alternating current (AC) into a direct current (DC). When the display unit 180 is implemented as a liquid crystal panel having a plurality of backlight lamps, the power supply unit 190 may be provided with an inverter (not shown) which can implement a PWM operation, so as to perform a brightness change or a dimming driving.

The remote controlling apparatus 200 transmits an input signal to the user input interface unit 150. In this case, may be used a Bluetooth method, a radio frequency (RF) communication method, an infrared ray (IR) communication method, an ultra wideband (UWB) method, a ZigBee method, etc. The remote controlling apparatus 200 may receive a video signal or an audio signal or a data signal output from the user input interface unit 150, thereby displaying or outputting in the form of an audio signal or a vibration.

The image display apparatus 100 may be a fixed type digital broadcasting receiver configured to receive at least one of a digital broadcasting of an ATSC (8-VSB) standard, a digital broadcasting of a DVB-T (COFDM) standard and a digital broadcasting of an ISDB-T (BST-OFDM) standard.

The image display apparatus is not provided with the display unit 180 and the audio output unit 185 of FIG. 1, which may be a wireless type which performs data transmission and reception with the display unit 180 and the audio output unit 185.

FIG. 1 is a block diagram showing an inner structure of the image display apparatus 100 according to the present invention. The respective components of the image display apparatus 100 may be integrated with each other or divided into a plurality of components according to a specification of the image display apparatus 100. More concretely, two or more components may be integrated as one, or one component may be divided into two or more components. A function performed by each component is not limited to the aforementioned function.

Differently from the structure of FIG. 1, the image display apparatus 100 may not be provided with the tuner 110 and the demodulation unit 120, but may receive image contents through the network interface unit 130 or the external device interface unit 135 and play the received image contents.

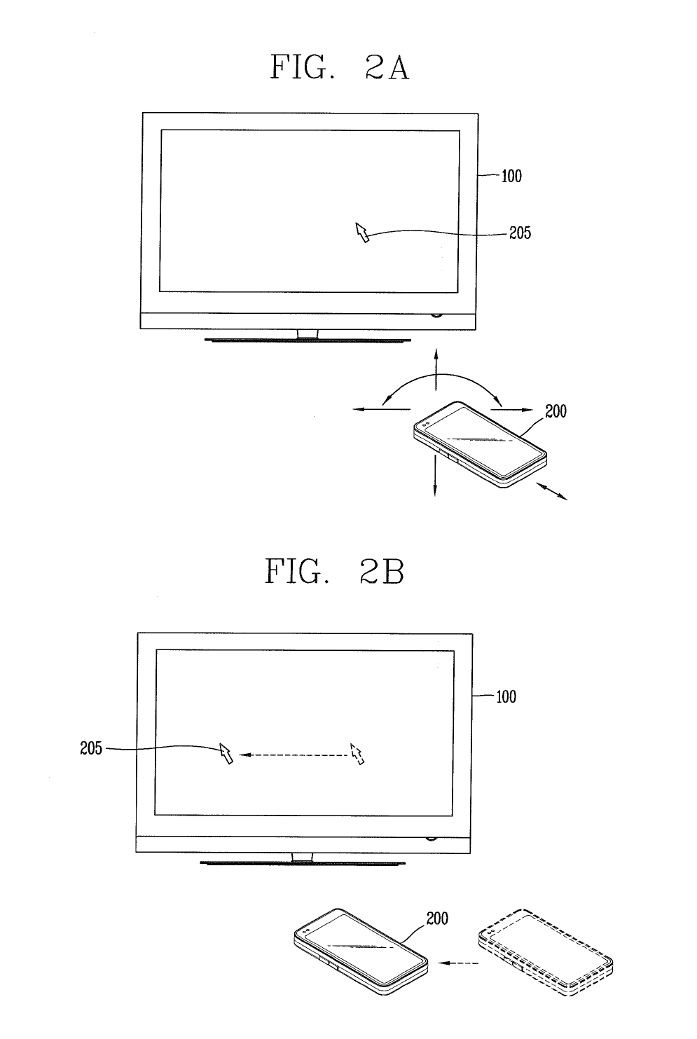

FIGS. 2A to 2C are views each showing an operation of the remote controlling apparatus of FIG. 1. Referring to FIGS. 2A to 2C, the remote controlling apparatus 200 may perform data transmission and reception with the image display apparatus 100 according to an RF communication standard or an IR communication standard.

FIG. 2A is a view showing that a pointer 205 corresponding to the remote controlling apparatus 200 is displayed on the display unit 180. A user may move or rotate the remote controlling apparatus 200 in up, lower, right and left directions (refer to FIG. 2B), or in back and forth directions (refer to FIG. 2C). The pointer 205 displayed on the image display apparatus 100 is moved in correspondence to a motion of the remote controlling apparatus 200. Since the pointer 205 is moved in correspondence to a motion of the remote controlling apparatus 200 in a three-dimensional space, the remote controlling apparatus 200 may be called a ‘space remote controller’.

FIG. 2B shows that the pointer 205 displayed on the image display apparatus 100 is moved to the left side when a user moves the remote controlling apparatus 200 to the left side. Information on motions of the remote controlling apparatus 200 detected by the sensing unit is transmitted to the image display apparatus 100. The image display apparatus 100 may calculate coordinates values of the pointer 205 based on the information on a motion of the remote controlling apparatus 200. The image display apparatus 100 may display the pointer 205 in correspondence to the calculated coordinates values.

FIG. 2C shows that a user moves the remote controlling apparatus 200 to a direction spacing from the display unit 180 in a state that a specific button of the remote controlling apparatus 200 has been pressed. In this case, a selected region of the display unit 180 corresponding to the pointer 205 may be zoomed-in to be displayed with an enlarged size. On the contrary, when a user moves the remote controlling apparatus 200 to a direction approaching to the display unit 180, a selected region of the display unit 180 corresponding to the pointer 205 may be zoomed-out to be displayed with a contracted size. Alternatively, when the remote controlling apparatus 200 is moved to be spaced from the display unit 180, a selected region may be zoomed-out. On the contrary, when the remote controlling apparatus 200 is moved to approach the display unit 180, a selected region may be zoomed-in.

In a state that a specific button of the remote controlling apparatus 200 has been pressed, motions of the remote controlling apparatus 200 in upper, lower, right and left directions may not be recognized. More concretely, when the remote controlling apparatus 200 is moved to be spaced from or to approach the display unit 180, only motions of the remote controlling apparatus 200 in back and forth directions may be recognized. In a state that a specific button of the remote controlling apparatus 200 has not been pressed, only the pointer 205 is moved according to motions of the remote controlling apparatus 200 in upper, lower, right and left directions.

A moving speed or a moving direction of the pointer 205 may correspond to a moving speed or a moving direction of the remote controlling apparatus 200.

The pointer indicates an object displayed on the display unit 180 in correspondence to an operation of the remote controlling apparatus 200. Accordingly, the pointer 205 may be implemented as an object having various shapes as well as the arrow shape. For instance, the pointer may be implemented as a point, a cursor, a prompt, a thick outer line, etc. The pointer 205 may be displayed as one point on a horizontal axis or a vertical axis, or may be displayed as a plurality of points such as a line and a surface.

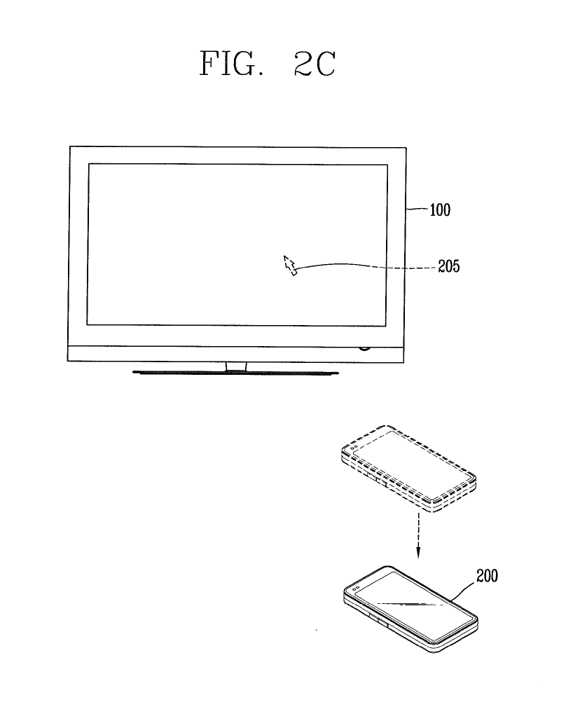

FIG. 3 is a view for explaining three axes relating to a tilt of the remote controlling apparatus according to the present invention. Information on a tilt obtained by a sensing unit may include information on a tilt angle including a pitch angle indicating a tilt based on an X-axis, a roll angle indicating a tilt based on a Y-axis, and a yaw angle indicating a tilt based on a Z-axis. The pitch angle indicates a rotation angle of the remote controlling apparatus 200 centering around an X-axis, the roll angle indicates a rotation angle of the remote controlling apparatus 200 centering around a Y-axis, and the yaw angle indicates a rotation angle of the remote controlling apparatus 200 centering around a Z-axis.

The pitch angle and the roll angle may be reference values by which it is determined whether a front surface of the remote controlling apparatus 200 is toward a geocentric direction or an opposite direction to a geocentric direction. The remote controlling apparatus 200 may determine its upside-down state based on the pitch angle and the roll angle.

The yaw angle may be a reference value by which it is determined whether a long edge of a front surface of the remote controlling apparatus 200 (any edge when the four edges have the same length) is horizontal or vertical with respect to a long edge of the display unit of the image display unit 100. The remote controlling apparatus 200 may determine its horizontal or vertical relation with respect to the image display apparatus 100 based on the yaw angle.

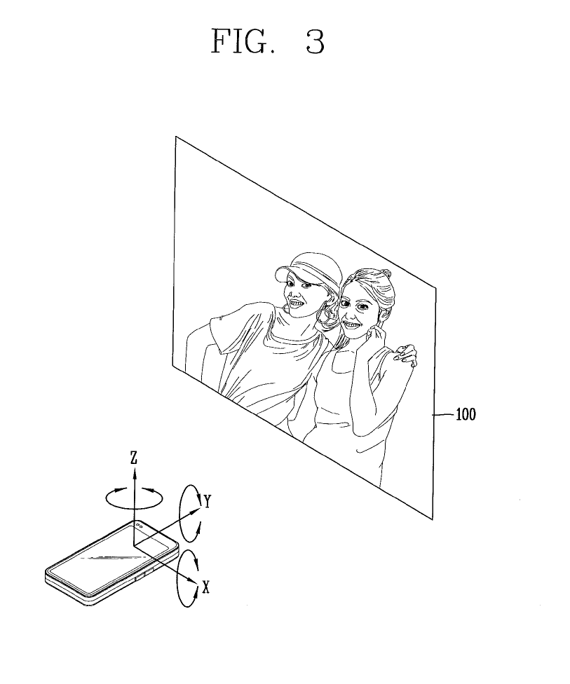

FIG. 4 is a block diagram showing an inner structure of the remote controlling apparatus of FIG. 1. Referring to FIG. 4, the remote controlling apparatus 200 may include a wireless communication unit 225, a user input unit 230, a sensing unit 240, an output unit 250, a power supply unit 260, a storage unit 270 and a controller 280.

The wireless communication unit 225 performs signal transmission and reception with the image display apparatus 100. In the present invention, the remote controlling apparatus 200 may be provided with an RF module 221 configured to perform signal transmission and reception with the image display apparatus 100 according to an RF communication standard. And, the remote controlling apparatus 200 may be provided with an IR module 223 configured to perform signal transmission and reception with the image display apparatus 100 according to an IR communication standard. The remote controlling apparatus 200 transmits information on motions of the remote controlling apparatus 200 to the image display apparatus 100 through the RF module 221. The remote controlling apparatus 200 may receive a signal transmitted from the image display apparatus 100 through the RF module 221. The remote controlling apparatus 200 may transmit, commands such as power ON/OFF, a channel change and a volume change, to the image display apparatus 100 through the IR module 223.

The user input unit 230 may be implemented as a keypad, buttons, a touch pad, a touch screen, etc. A user may input commands associated with the image display apparatus 100 to the remote controlling apparatus 200, through the user input unit 230. In a case that the user input unit 230 is provided with hard key buttons, a user may input commands associated with the image display apparatus 100 to the remote controlling apparatus 200 by pushing the hard key buttons. In a case that the user input unit 230 is provided with a touch screen, a user may input commands associated with the image display apparatus 100 to the remote controlling apparatus 200 by touching soft keys of the touch screen. The user input unit 230 may be provided with various types of input means (e.g., scroll keys and jog keys) which can be manipulated by a user. However, the present invention is not limited to this.

The user input unit 230 includes a text input unit 231. The text input unit 231 is disposed on one surface of a case (a casing, a housing, a cover, etc.) which constitutes the appearance of the remote controlling apparatus 200, and receives a text input from a user. The text input unit 231 may receive or may not receive a text input according to an activated or deactivated state determined by the controller 280.

The text input unit 231 may be implemented as a keypad or a touch pad. Alternatively, the text input unit 231 may be one of a QWERTY type keyboard and a non-QWERTY type keyboard.

The user input unit 230 includes an operation control input unit 233. The operation control input unit 233 is disposed on one surface of a case (a casing, a housing, a cover, etc.) which constitutes the appearance of the remote controlling apparatus 200, and includes at least one function key for controlling the operation of the image display apparatus 100. The operation control input unit 233 may be a keypad or a touchpad.

The operation control input unit 233 may receive or may not receive an operation control input according to an activated or deactivated state determined by the controller 280. An activated state of the text input unit 231 may be opposite to an activated state of the operation control input unit 233. For instance, when the text input unit 231 is in an activated state, the operation control input unit 233 is in a deactivated state. On the contrary, when the text input unit 231 is in a deactivated state, the operation control input unit 233 is in an activated state.

According to a first embodiment of the present invention, the text input unit 231 and the operation control input unit 233 may be disposed on facing surfaces of the case. For instance, the text input unit 231 may be disposed on a front surface (or a rear surface) of the case, and the operation control input unit 233 may be disposed on a rear surface (or a front surface) of the case.

According to a second embodiment of the present invention, the text input unit 231 and the operation control input unit 233 may be disposed on the same surface of the case. For instance, the text input unit 231 and the operation control input unit 233 may be disposed on a front surface or a rear surface of the case. The sensing unit 240 may include at least one of a gyro sensor 241, an acceleration sensor 243 and a geomagnetic sensor 245. By using one of the sensors or by combining two or more sensors with each other, motions and/or a tilt of the remote controlling apparatus 200 may be detected.

The gyro sensor 241 is an inertia sensor for measuring a rotation angular speed, which may detect information on motions of the remote controlling apparatus 200. For instance, the gyro sensor 241 may detect information on motions of the remote controlling apparatus 200 based on X, Y and Z axes.

The acceleration sensor 243 may measure a gravitational acceleration with respect to a terrestrial gravitation, thereby measuring a tilted degree of the remote controlling apparatus 200 with respect to the ground surface. For instance, the acceleration sensor 243 may compensate for a tilt of the remote controlling apparatus 200.

The geomagnetic sensor 245 may detect an azimuth based on information on a magnetic field horizontally formed on the ground surface. The sensing unit 240 detects motions of the remote controlling apparatus 200, and outputs information relating to the detected motions. More concretely, the sensing unit 240 outputs, to the controller 280, information on the operation of the remote controlling apparatus 200 with respect to coordinates systems for X, Y and Z axes. For instance, the remote controlling apparatus 200 detects information on an angular acceleration of the remote controlling apparatus 200 through the gyro sensor 241, and controls a pointer by compensating for a tilt through the acceleration sensor 243 and/or the geomagnetic sensor 245.

The sensing unit 240 detects a tilt of the remote controlling apparatus 200, and outputs information on the detected tilt. That is, the sensing unit 240 detects a tilt of the remote controlling apparatus 200 with respect to coordinates systems for X, Y and Z axes, and outputs information on the detected tilt to the controller 280. For instance, the remote controlling apparatus 200 detects information on a tilt thereof through the acceleration sensor 243 or the geomagnetic sensor 245, and controls a pointer thereof based on the information (determines whether to control the pointer or not). Alternatively, the remote controlling apparatus 200 controls activation of the text input unit 231 and/or the operation control input unit 233.

The sensing unit 240 may be further provided with a distance measuring sensor (not shown) configured to sense a distance between the remote controlling apparatus and the display unit 180.

The output unit 250 may output a video or audio signal corresponding to manipulations of the user input unit 230 or corresponding to a signal transmitted from the image display apparatus 100. Through the output unit 250, a user may recognize whether the user input unit 230 has been manipulated or whether the image display apparatus 100 has been controlled.

For instance, the output unit 250 may further include an LED module 251 operated when the user input unit 230 is manipulated or a signal transmission or reception is performed with the image display apparatus 100 through the wireless communication unit 225, a vibration module 253 for generating a vibration, an audio output module 255 for outputting an audio signal, and a display module 257 for outputting a video signal.

According to the second embodiment of the present invention, when the text input unit 231 and the operation control input unit 233 are implemented as a touchpad, the display module 257 may selectively display one or more function keys of the text input unit 231, and one or more function keys of the operation control input unit 233. More concretely, under control of the controller 280, the display module 257 may display one or more function keys of one activated input unit between the text input unit 231 and the operation control input unit 233.

The power supply unit 260 supplies power to the remote controlling apparatus 200. If the remote controlling apparatus 200 is not operated for a predetermined time, the power supply unit 260 stops power supply to prevent power from being wasted. Upon manipulation of a predetermined key of the remote controlling apparatus 200, the power supply unit 260 may resume power supply.

The storage unit 270 may store therein various types of programs for controlling or operating the remote controlling apparatus 200, application data, etc.

If the remote controlling apparatus 200 is configured to wirelessly transmit and receive signals to/from the image display apparatus 100 through the RF module 221, the remote controlling apparatus 200 transmits and receives signals to/from the image display apparatus 100 through a predetermined frequency band. The controller 280 of the remote controlling apparatus 200 may store, in the storage unit 270, information on a frequency band through which transmission and reception of signals can be performed between the remote controlling apparatus 200 and the paired image display apparatus 100, etc.

The storage unit 270 stores therein information on threshold values, the information by which it is determined to activate or deactivate the text input unit 231 and/or the operation control input unit 233. The information on threshold values includes information on a threshold value corresponding to at least one of a pitch angle, a roll angle and a yaw angle.

Each information on a threshold value corresponding to at least one of a pitch angle, a roll angle and a yaw angle may include information on a plurality of threshold values. The information on a plurality of threshold values may include information on a first threshold value by which activation of the text input unit 231 (deactivation of the operation control input unit 233) is determined, and information on a second threshold value by which deactivation of the text input unit 231 (activation of the operation control input unit 233) is determined.

The storage unit 270 stores therein information on an activated or deactivated state of the text input unit 231 and/or the operation control input unit 233.

The controller 280 controls an overall operation of the remote controlling apparatus 200. The controller 280 may transmit, to the image display apparatus 100, a signal corresponding to manipulations of a predetermined key of the user input unit 230, or a signal corresponding to motions of the remote controlling apparatus 200 sensed by the sensing unit 240, through the wireless communication unit 225.

The controller 280 may selectively operate a first mode or a second mode based on a tilt of the remote controlling apparatus detected by the sensing unit 240. While the controller 280 controls the wireless communication unit 225 to transmit a text input received by the text input unit 231 in the first mode, the controller 280 controls the wireless communication unit 225 to transmit information on a motion or a tilt of the remote controlling apparatus 200 detected by the sensing unit 240 in the second mode. Accordingly, the user may input a text information to the image display apparatus 100 in the first mode, and control a pointer displayed on the image display apparatus 100 in the second mode through the remote controlling apparatus 200.

According to the first embodiment of the present invention, one surface on which the text input unit 231 is disposed is toward an opposite direction to the geocentric direction in the first mode, while one surface on which the text input unit 231 is disposed is toward a direction to the geocentric direction in the second mode.

The controller 280 determines an activated or deactivated state of the text input unit 231, and calculates a threshold range of a pitch angle or a roll angle of the remote controlling apparatus 200 according to the determined activated or deactivated state. And, the controller 280 compares a pitch angle or a roll angle of the remote controlling apparatus 200 detected by the sensing unit 240 with the threshold range, and controls activation of the text input unit 231 based on a comparison result.

According to the second embodiment of the present invention, a longitudinal direction is a horizontal direction in the first mode and a vertical direction in the second mode when the remote controlling apparatus 200 is formed in a rectangular-parallelepiped-shape.

The controller 280 determines an activated or deactivated state of the text input unit 231, and calculates a threshold range of a yaw angle of the remote controlling apparatus 200 according to the determined activated or deactivated state. And, the controller 280 compares a yaw angle of the remote controlling apparatus 200 detected by the sensing unit 240 with the threshold range, and controls activation of the text input unit 231 based on a comparison result.

The controller 280 controls receiving the text input to be activated and detecting the motion of the remote controlling apparatus 200 to be deactivated if the detected tilt of the remote controlling apparatus 200 is a first value. Also, the controller 280 controls receiving the text input to be deactivated and detecting the motion of the remote controlling apparatus 200 to be activated if the detected tilt of the remote controlling apparatus 200 is a second value.

Moreover, the controller 280 controls the wireless communication unit 225 to transmit an input of a broadcasting-related operation of the image display apparatus received by the operation control input unit 233 in the second mode. The controller 280 controls receiving input of a broadcasting-related operation of the image display apparatus to be deactivated if the detected tilt of the remote controlling apparatus 200 is a first value while the controller 280 controls receiving input of a broadcasting-related operation of the image display apparatus to be activated if the detected tilt of the remote controlling apparatus 200 is a first value.

The controller 280 controls activation of the text input unit 231 and/or the operation control input unit 233 based on information relating to a detected tilt of the remote controlling apparatus 200. The information relating to the detected tilt may include at least one of a pitch angle, a roll angle and a yaw angle. When controlling activation of the text input unit 231, the controller 280 may control the operation control input unit 233 together. More concretely, when the text input unit 231 is converted into an activated state from a deactivated state, the controller 280 may convert the operation control input unit 233 to a deactivated state from an activated state.

Alternatively, when the text input unit 231 is converted into a deactivated state from an activated state, the controller 280 may convert the operation control input unit 233 to an activated state from a deactivated state. When controlling activation of the text input unit 231, the controller 280 may determine whether to control a pointer or not. More concretely, the controller 280 may not control a pointer when the text input unit 231 is in an activated state, but may control the pointer when the text input unit 231 is in a deactivated state.

According to the embodiments of the present invention, the remote controlling apparatus 200 may be a mobile terminal. For example, the remote controlling apparatus 200 further includes an wireless communication unit (not shown) typically comprising one or more elements allowing radio communication between the remote controlling apparatus 200 and a wireless communication system, or allowing radio communication between radio communication the remote controlling apparatus 200 and a network in which the remote controlling apparatus 200 is located.

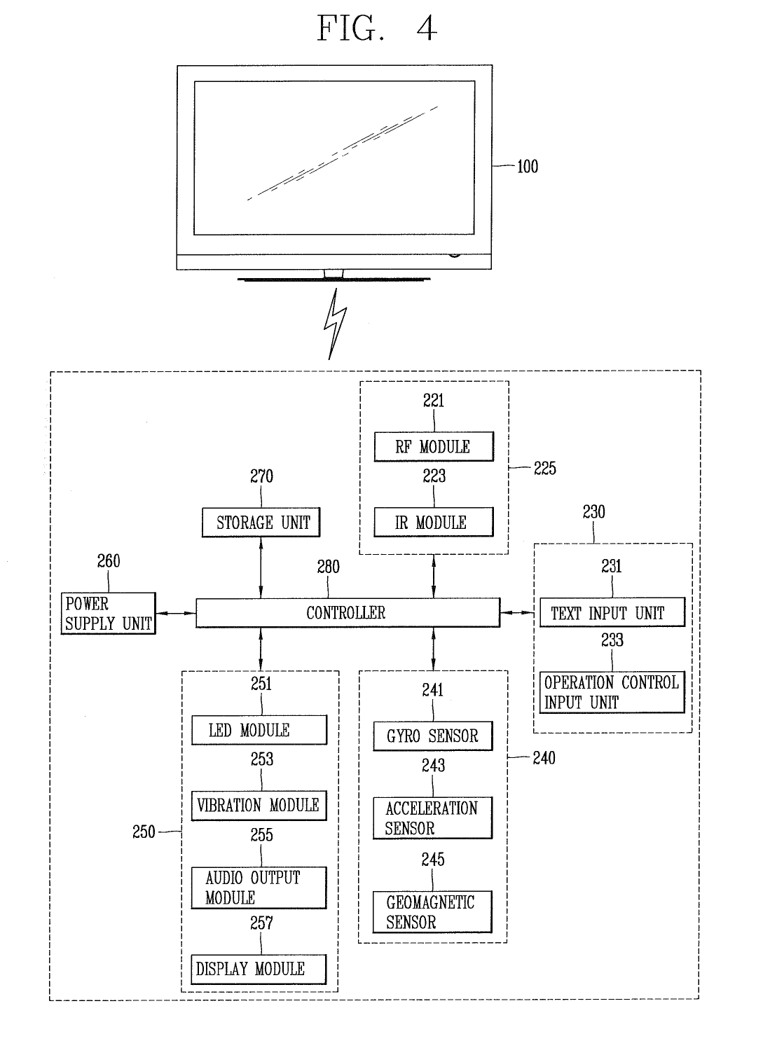

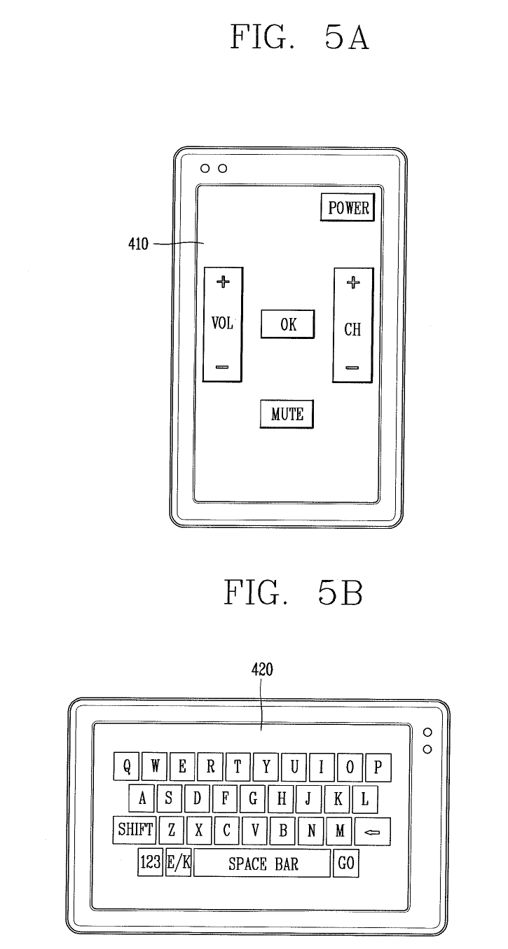

FIG. 5A is a view showing function keys of the operation control input unit according to the present invention. The function keys 410 of the operation control input unit 233 may include one or more function keys for controlling a broadcasting-related operation of the image display apparatus 100 by the remote controlling apparatus 200, such as ON/OFF of a power of the image display apparatus 100, control of a volume and a channel of a broadcasting channel being currently received, and an OK for a command.

FIG. 5B is a view showing function keys of the text input unit according to the present invention. When the text input unit 231 is a QWERTY type keyboard, the function keys 420 of the text input unit 231 may include alphabetical keys arranged in a QWERTY manner, a shift key for toggling a plurality of meanings allocated to the keys with each other, a space key for forming a space, a backspace key for deleting a character, a mode conversion key for toggling an alphabet mode and a number mode with each other, a mode conversion key for toggling an alphabet mode and a Korean mode with each other, an enter key for executing commands or for yes, etc.

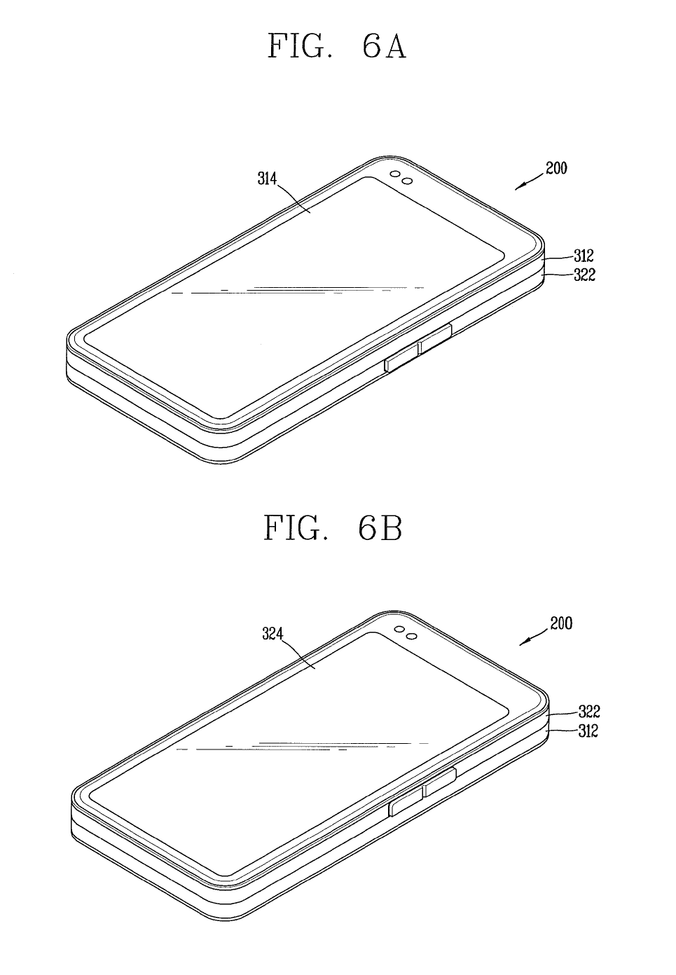

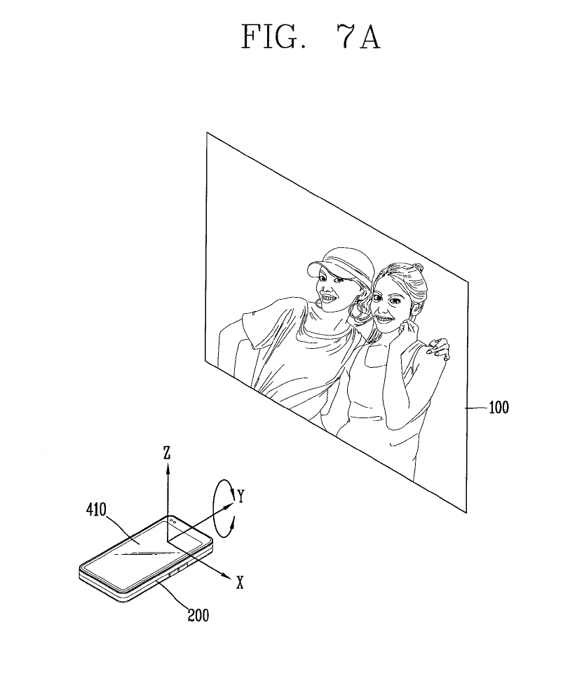

FIG. 6A is a front perspective view of the remote controlling apparatus according to the present invention. The remote controlling apparatus 200 is provided with a bar type of body. The body includes a case (a casing, a housing, a cover, etc.) which constitutes the appearance of the remote controlling apparatus 200. The case may be classified into a front case 312 and a rear case 322.

A space formed by the front case 312 and the rear case 322 may accommodate various components therein. At least one intermediate case may further be disposed between the front case 312 and the rear case 322. Such cases 312 and 322 may be formed by injection-molded synthetic resin, or may be formed using a metallic material such as stainless steel (STS) or titanium (Ti).

On a front surface 314 of the body (especially, on the front case 312), may be disposed an LED module 251, an audio output module 255, a display module 257, etc.

FIG. 6B is a rear perspective view of the remote controlling apparatus of FIG. 6A according to the present invention. On a rear surface 324 of the body (especially, on the rear case 322), may be disposed an LED module 251, an audio output module 255, a display module 257, etc.

According to the first embodiment of the present invention, the function keys 410 of the operation control input unit 233 may be disposed on the front surface 314 of the body, and the function keys 420 of the text input unit 231 may be disposed on the rear surface 324 of the body.

According to the second embodiment of the present invention, the display module 257 may be disposed on the front surface 314 of the body. The text input unit 231 and the operation control input unit 233 may be implemented as a touch sensor. In this case, the display module 257, the text input unit 231 and the operation control input unit 233 may have a layered structure. Under control of the controller 280, the display module 257 may display the function keys 420 or 410 of one activated input unit between the text input unit 231 and the operation control input unit 233.

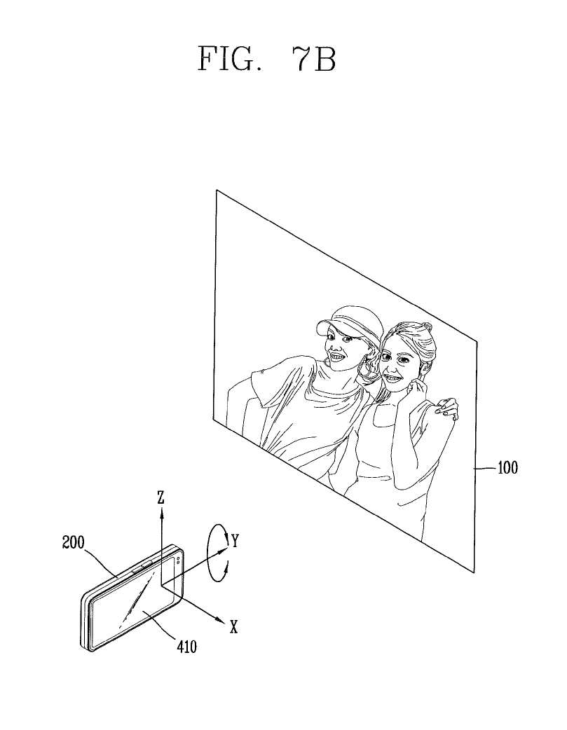

FIGS. 7A to 7C are conceptual views for explaining a method for controlling an operation of the remote controlling apparatus according to the first embodiment of the present invention.

According to the first embodiment of the present invention, the function keys 410 of the operation control input unit 233 may be disposed on the front surface 314 of the remote controlling apparatus 200, and the function keys 420 of the text input unit 231 may be disposed on the rear surface 324 of the remote controlling apparatus 200.

Referring to FIG. 7A, when the text input unit 231 is in a deactivated state, the front surface 314 of the remote controlling apparatus 200 is toward an opposite direction to a geocentric direction, and the rear surface 324 of the remote controlling apparatus 200 is toward a geocentric direction.

In this case, if the remote controlling apparatus 200 is rotated centering around a Y axis, a roll angle is changed.

Referring to FIG. 7B, the remote controlling apparatus 200 is rotated centering around the Y axis by a predetermined angle from the previous state shown in FIG. 7A, thereby having a changed roll angle. In this case, if the remote controlling apparatus 200 having been rotated has a tilt which is within a threshold range, the text input unit 231 maintains a deactivated state.

Referring to FIG. 7C, the remote controlling apparatus 200 is more rotated centering around the Y axis by a predetermined angle from the previous state shown in FIG. 7B, thereby having a more changed roll angle. In this case, if the remote controlling apparatus 200 having been rotated has a tilt which is not within a threshold range, the text input unit 231 is converted into an activated state from a deactivated state. When the text input unit 231 is in an activated state, the front surface 314 of the remote controlling apparatus 200 is toward a geocentric direction, and the rear surface 324 is toward an opposite direction to a geocentric direction.

FIGS. 7A to 7C show a method for controlling the operation of the remote controlling apparatus 200 according to a change of a roll angle. However, the method may be also implemented according to a change of a pitch angle.

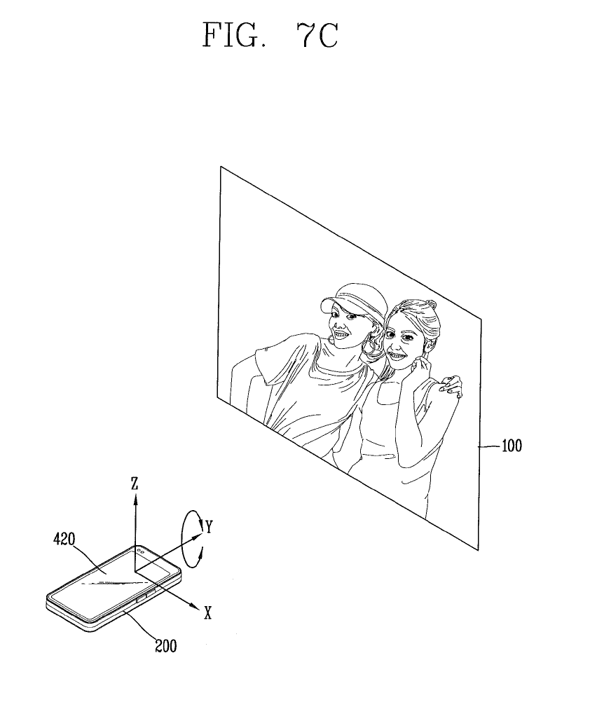

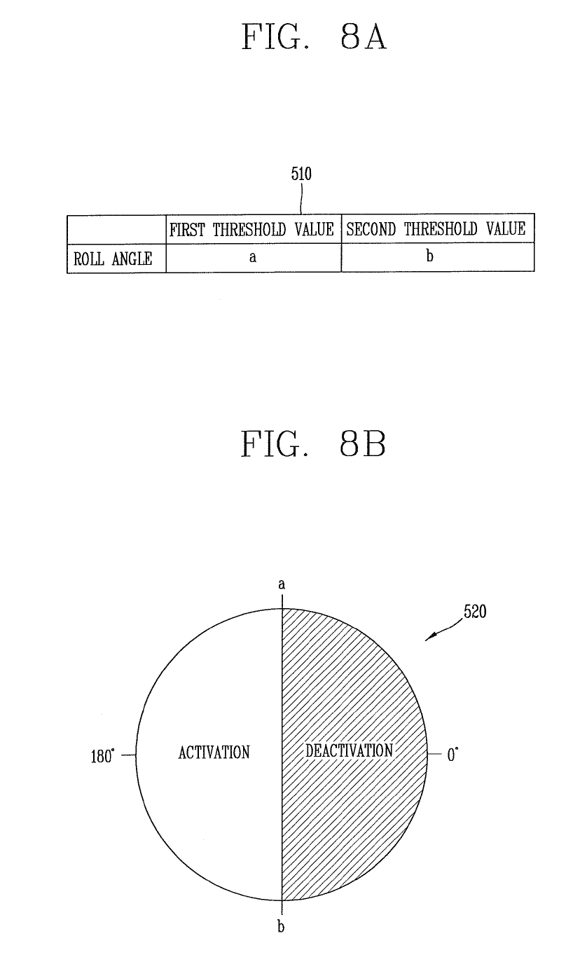

FIG. 8A is a view showing a threshold value table of the remote controlling apparatus according to a first embodiment of the present invention. The threshold value table 510 includes a first threshold value (a) corresponding to a roll angle, and a second threshold value (b) corresponding to a roll angle.

FIG. 8B is a view showing an activated region and a deactivated region of the remote controlling apparatus according to the first embodiment of the present invention.

Referring to a roll angle graph 520 of FIG. 8B, a section from the second threshold value (b) to the first threshold value (a) in a counterclockwise direction corresponds to a deactivated region of the text input unit 231. And, a section from the first threshold value (a) to the second threshold value (b) in a counterclockwise direction corresponds to an activated region of the text input unit 231.

It is assumed that a roll angle is ‘0’ when the rear surface 324 of the remote controlling apparatus 200 is precisely toward a geocentric direction. In this state, the text input unit 231 is deactivated. In a state that the roll angle is ‘0’, the text input unit 231 maintains a deactivated state until the roll angle reaches the first threshold value (a) as the remote controlling apparatus 200 is rotated centering around the X-axis.

In a state that the roll angle has reached the first threshold value (a), if the roll angle exceeds the first threshold value (a) as the remote controlling apparatus 200 is more rotated centering around the Y-axis, the text input unit 231 is converted into an activated state. Until the roll angle reaches the second threshold value (b) as the remote controlling apparatus 200 is more rotated centering around the Y-axis, the text input unit 231 maintains an activated state. In a state that the roll angle has reached the second threshold value (b), if the roll angle exceeds the second threshold value (b) as the remote controlling apparatus 200 is more rotated centering around the Y-axis, the text input unit 231 is converted into a deactivated state.

FIGS. 8A and 8B show a method for controlling the operation of the remote controlling apparatus 200 according to a change of a roll angle. However, the method may be also implemented according to a change of a pitch angle.

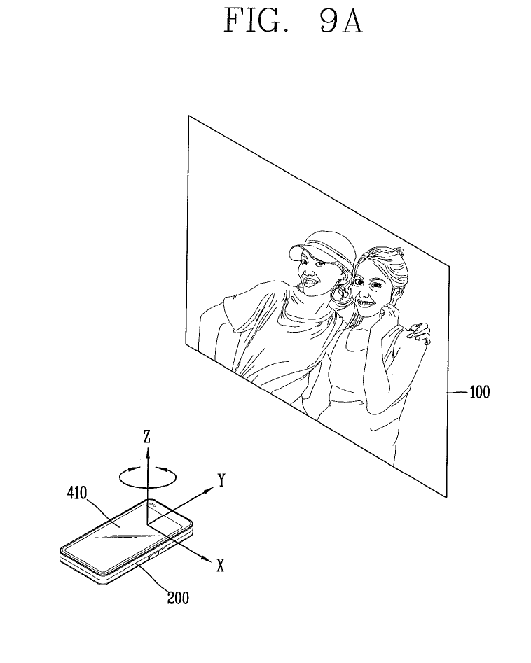

FIGS. 9A to 9C are conceptual views for explaining a method for controlling an operation of a remote controlling apparatus according to a second embodiment of the present invention.

According to the second embodiment of the present invention, the display module 257 disposed on the front surface 314 of the remote controlling apparatus 200 is configured to display the function keys 410 of the operation control input unit 233 when the text input unit 231 is in a deactivated state and the operation control input unit 233 is in an activated state. And, the display module 257 is configured to display the function keys 420 of the text input unit 231 when the text input unit 231 is in an activated state and the operation control input unit 233 is in a deactivated state.

Referring to FIG. 9A, when the text input unit 231 is in a deactivated state, a long edge of the front surface 314 of the remote controlling apparatus 200 is perpendicular to an extended surface of the display unit of the image display apparatus 100. In this state, if the remote controlling apparatus 200 is rotated centering around a Z-axis, a yaw angle is changed.

Referring to FIG. 9B, the remote controlling apparatus 200 is rotated by a predetermined angle centering around the Z-axis from the previous state shown in FIG. 9A, thereby having a changed yaw angle. If the yaw angle is within a threshold range after the remote controlling apparatus 200 has been rotated, the text input unit 231 maintains a deactivated state.

Referring to FIG. 9C, the remote controlling apparatus 200 is more rotated by a predetermined angle centering around the Z-axis from the previous state shown in FIG. 9B, thereby having a changed yaw angle. If the yaw angle is not within a threshold range after the remote controlling apparatus 200 has been rotated, the text input unit 231 is converted into an activated state from a deactivated state. When the text input unit 231 is in an activated state, a long edge of the front surface 314 of the remote controlling apparatus 200 is parallel to an extended surface of the display unit of the image display apparatus 100.

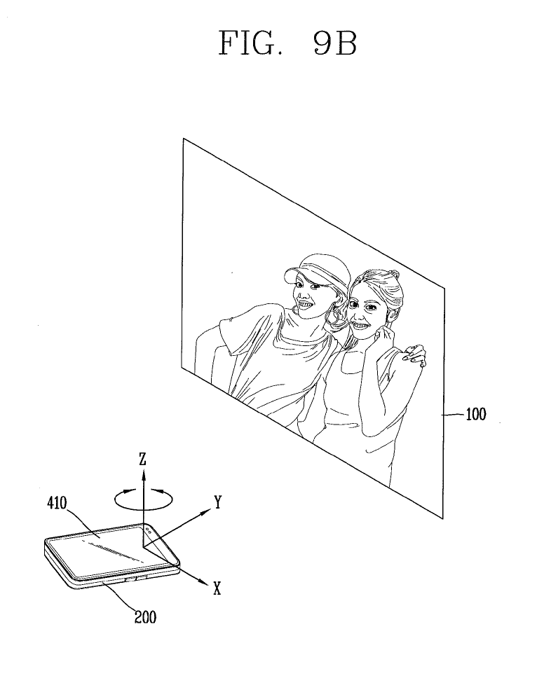

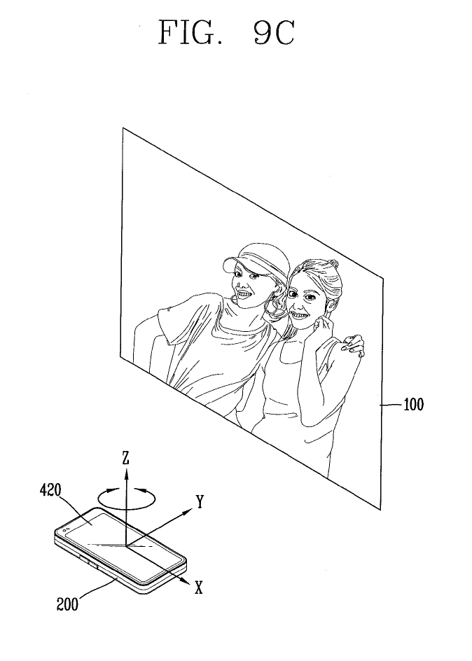

FIG. 10A is a view showing a threshold value table of a remote controlling apparatus according to a second embodiment of the present invention.

The threshold value table 610 includes a first threshold value (p) corresponding to a yaw angle, and a second threshold value (q) corresponding to a yaw angle.

FIG. 10B is a view showing an activated region and a deactivated region of the remote controlling apparatus according to the second embodiment of the present invention.

Referring to a yaw angle graph 620 of FIG. 10B, a section from the second threshold value (q) to the first threshold value (p) in a counterclockwise direction corresponds to a deactivated region of the text input unit 231. And, a section from the first threshold value (p) to the second threshold value (q) in a counterclockwise direction corresponds to an activated region of the text input unit 231.

It is assumed that a yaw angle is ‘0’ when a long edge of the front surface 314 of the remote controlling apparatus 200 is perpendicular to an extended surface of the display unit of the image display apparatus 100. In this state, the text input unit 231 is deactivated. In a state that the yaw angle is ‘0’, the text input unit 231 maintains a deactivated state until the yaw angle reaches the first threshold value (p) as the remote controlling apparatus 200 is rotated centering around the Z-axis.

In a state that the yaw angle has reached the first threshold value (p), if the yaw angle exceeds the first threshold value (p) as the remote controlling apparatus 200 is more rotated centering around the Z-axis, the text input unit 231 is converted into an activated state. Until the yaw angle reaches the second threshold value (q) as the remote controlling apparatus 200 is more rotated centering around the Z-axis, the text input unit 231 maintains an activated state.

In a state that the yaw angle has reached the second threshold value (q), if the yaw angle exceeds the second threshold value (q) as the remote controlling apparatus 200 is more rotated centering around the Z-axis, the text input unit 231 is converted into a deactivated state.

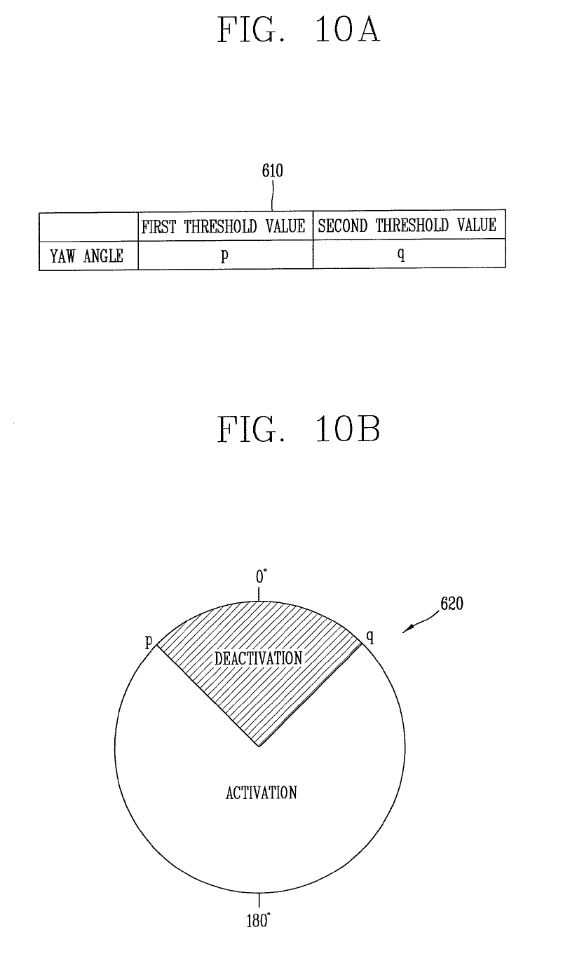

FIG. 11 is a flowchart showing processes for controlling the operation of the remote controlling apparatus according to the present invention.

The sensing unit 240 detects a tilt of the remote controlling apparatus 200 (S100). More concretely, the sensing unit 240 determines a tilted angle of the remote controlling apparatus 200 with respect to X, Y and Z coordinates systems.

And, the controller 280 determines an operation mode of the remote controlling apparatus 200 (S200). According to the first embodiment of the present invention, the controller 280 determines the operation mode of the remote controlling apparatus 200 based on whether one surface on which the text input unit is disposed is toward a geocentric direction or an opposite direction to the geocentric direction. According to the second embodiment of the present invention, the controller 280 determines the operation mode of the remote controlling apparatus 200 based on a longitudinal direction is a horizontal direction or a vertical direction when the remote controlling apparatus 200 is formed in a rectangular-parallelepiped-shape.

And, the controller 280 identifies whether the determined operation mode of the remote controlling apparatus 200 is a first mode or not (namely, a second mode) (S300).

If it is identified that the determined operation mode of the remote controlling apparatus 200 is the first mode, the controller 280 controls the wireless communication unit 225 to transmit a text input received by the text input unit 231 to the image display apparatus 100 (S400). Moreover, the controller 280 controls the wireless communication unit 225 not to transmit information on a motion or a tilt of the remote controlling apparatus 200 detected by the sensing unit 240. In this case, the controller 280 controls the wireless communication unit 225 not to transmit information on a control input of a broadcasting-related operation of the image display apparatus 100 received by the operation control input unit 232.

However, if it is identified that the determined operation mode of the remote controlling apparatus 200 is not the first mode (namely, a second mode), the controller 280 controls the wireless communication unit 225 to transmit information on a motion or a tilt of the remote controlling apparatus 200 detected by the sensing unit 240 to the image display apparatus 100 (S500). Moreover, the controller 280 controls the wireless communication unit 225 not to transmit a text input received by the text input unit 230 to the image display apparatus 100. In this case, the controller 280 controls the wireless communication unit 225 to transmit information on a control input of a broadcasting-related operation of the image display apparatus 100 received by the operation control input unit 232.

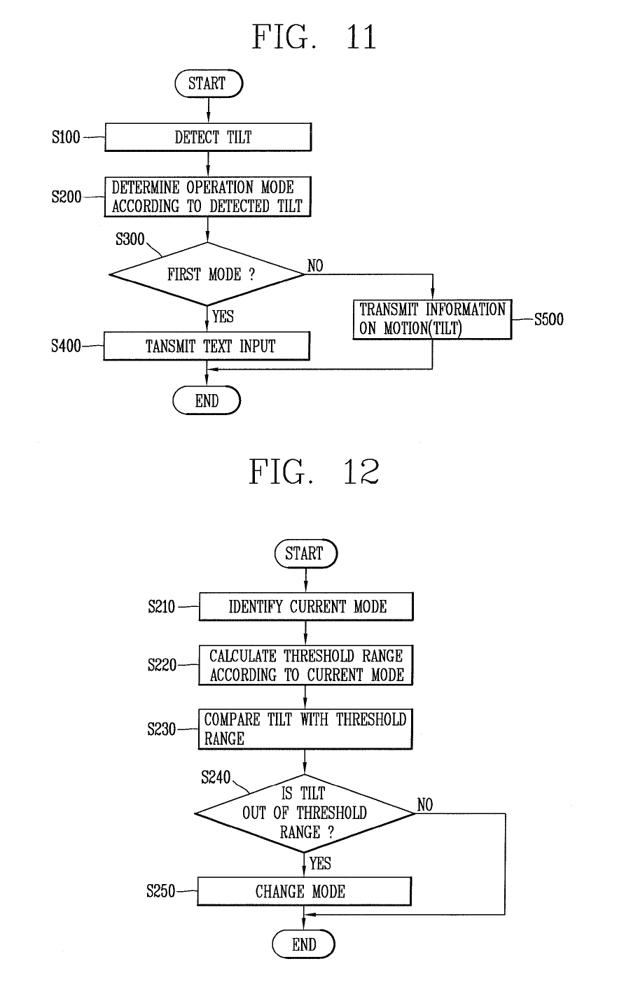

FIG. 12 is a flowchart showing a step of determining operation mode of the remote controlling apparatus 200 of FIG. 11 (S200). The controller 280 identifies a current operation mode of the remote controlling apparatus 200 (S210). For example, the controller 280 reads, from the storage unit 270, information on the current operation mode of the remote controlling apparatus 200.

The controller 280 reads information on threshold values from the storage unit 270, and calculates a threshold range based on the read information on threshold values and information on the current operation mode of the remote controlling apparatus 200 (S220).

The controller 280 compares the tilt detected by the sensing unit 240 with the calculated threshold range (S230).

Then, the controller 280 determines whether the tilt detected by the sensing unit 240 is not within the calculated threshold range (S240).

If it is determined in S240 that the tilt detected by the sensing unit 240 is not within the calculated threshold range, the controller 280 changes the operation mode of the remote controlling apparatus (S250). On the contrary, if the tilt detected by the sensing unit 240 is within the calculated threshold range, the controller 280 does not change the operation mode of the remote controlling apparatus (maintains a current operation mode).

The present invention may have the following advantages.

Firstly, key button-type text input means may be selectively utilized based on information on a tilt of the remote controlling apparatus having a three-dimensional pointing function, the tilt detected by the sensing unit. This may allow a user to conveniently perform a text input, and may prevent a mal-operation of the text input means due to a pointing function.

Secondly, the sensing unit required to execute a pointing function may be utilized to selectively use the text input means. This may be advantageous in the aspects of costs of a hardware. Furthermore, this may solve a spatial problem due to an additional arrangement of the text input means for precise and stable pointing function.

The remote controlling apparatus and the method for controlling the same according to the present invention may be implemented as a program code stored in a computer-readable storage medium. The storage medium may include ROM, RAM, CD-ROM, a magnetic tape, a floppy disc, an optical data storage device, etc. And, the storage medium may be implemented as carrier wave (transmission through the Internet). Alternatively, the computer-readable storage medium may be distributed to a computer system connected to a network, and a program code may be stored and executed in a distributed manner.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A remote controlling apparatus for controlling a pointer displayed on a screen of a display apparatus by a three-dimensional operation, the remote controlling apparatus comprising:
a housing;
a text input unit disposed on one surface of the housing, and configured to receive a text input;
a sensing unit configured to detect a tilt and a motion of the remote controlling apparatus; and
a controller configured to selectively operate a first mode to transmit the text input to the display apparatus or a second mode to transmit information on the detected motion of the remote controlling apparatus to the display apparatus based on the detected tilt of the remote controlling apparatus.

2. The remote controlling apparatus of claim 1, wherein the controller controls receiving the text input to be activated and detecting the motion of the remote controlling apparatus to be deactivated if the detected tilt of the remote controlling apparatus is a first value.

3. The remote controlling apparatus of claim 1, wherein the controller controls receiving the text input to be deactivated and detecting the motion of the remote controlling apparatus to be activated if the detected tilt of the remote controlling apparatus is a second value.

4. The remote controlling apparatus of claim 1, further comprising an operation control input unit configured to control a broadcasting-related operation of the display apparatus in the second mode.

5. The remote controlling apparatus of claim 4, wherein the operation control input unit is disposed on a surface facing one surface of the housing.

6. The remote controlling apparatus of claim 5, wherein the controller selectively operates the first mode or the second mode based on whether one surface of the housing is toward a geocentric direction or an opposite direction to the geocentric direction.

7. The remote controlling apparatus of claim 4, wherein the operation control input unit is disposed on the same surface as one surface of the housing.

8. The remote controlling apparatus of claim 7, wherein the remote controlling apparatus is formed in a rectangular-parallelepiped-shape, and the controller selectively operates the first mode or the second mode based on a longitudinal direction is a horizontal direction or a vertical direction.

9. The remote controlling apparatus of claim 7, further comprising a display unit configured to display one or more function keys of the text input unit, and one or more function keys of the operation control input unit,
wherein the controller is configured to control the display unit such that one or more function keys of one activated input unit between the text input unit and the operation control input unit are displayed.

10. The remote controlling apparatus of claim 1, wherein the text input unit is implemented as a QWERTY type keyboard or a non-QWERTY type keyboard.

11. The remote controlling apparatus of claim 1, wherein the sensing unit comprises an acceleration sensor to detect the tilt of the remote controlling apparatus and a gyro sensor to detect the motion of the remote controlling apparatus.

12. The remote controlling apparatus of claim 1, further comprising a wireless communication unit configured to transmit the text input to the display apparatus in the first mode and the information on the motion of the remote controlling apparatus to the display apparatus in the second mode.

13. The remote controlling apparatus of claim 1, wherein the remote controlling apparatus is a mobile terminal.

14. A remote controlling apparatus for controlling a pointer displayed on a screen of a display apparatus by a three-dimensional operation, the remote controlling apparatus comprising:
a housing;
a text input unit disposed on one surface of the housing, and configured to receive a text input;
a sensing unit configured to detect a tilt of the remote controlling apparatus; and
a controller configured to selectively operate a first mode to transmit the text input to the display apparatus or a second mode to transmit information on the detected tilt of the remote controlling apparatus based on the detected tilt of the remote controlling apparatus.

15. The remote controlling apparatus of claim 14, wherein the controller controls receiving the text input to be activated if the detected tilt of the remote controlling apparatus is a first value.

16. The remote controlling apparatus of claim 14, wherein the controller controls receiving the text input to be deactivated if the detected tilt of the remote controlling apparatus is a second value.

17. The remote controlling apparatus of claim 14, further comprising an operation control input unit configured to control a broadcasting-related operation of the display apparatus in the second mode.

18. The remote controlling apparatus of claim 17, wherein the operation control input unit is disposed on a surface facing one surface of the housing.

19. The remote controlling apparatus of claim 17, wherein the operation control input unit is disposed on the same surface as one surface of the housing.

20. The remote controlling apparatus of claim 14, wherein the remote controlling apparatus is a mobile terminal.
